(19) United States
(12) Patent Application Publication
(10) Pub. No.: US 2002/0053460 A1
(43) Pub. Date: May 9, 2002

(54) Composite power cable

(76) Inventors: Yoshiteru Takeda, Tokyo (JP); Ichiro Kobayashi, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/961,634

(22) Filed: Sep. 21, 2001

Related U.S. Application Data
(63) Continuation of application No. PCT/JP01/00495, filed on Jan. 25, 2001.

(30) Foreign Application Priority Data
Jan. 25, 2000 (JP) 2000-015825
Feb. 28, 2000 (JP) 2000-051759

(51) Int. Cl. H01B 7/00

(52) U.S. Cl. 174/117 F

(57) ABSTRACT

To provide a low price, easy to produce, and easy to lay composite power cable, comprised of a pipe (4) able to receive a communication cable such as an optical fiber and an insulated conductor (3). A plurality of insulated conductors (3) each comprised of a conductor (1) and an insulator (2) and at least one pipe (4) are arranged in a line in a direction perpendicular to the longitudinal direction and are covered all together by a covering (7) when arranged in a straight line in the longitudinal direction. Preferably, an outer diameter of the pipe is made not more than 1.2 times the maximum value of an outer diameter of an insulated conductor arranged adjacently. More preferably, grooves are provided in the longitudinal direction of the cable in the two side surfaces in a width direction of the flat-shaped covering.

### TECHNICAL FIELD

The present invention relates to a composite power cable comprised of a power cable used for indoor wiring etc. combined with an optical fiber, a communication cable, or other communication use line-shaped member.

### PRIOR ART

The development of the Internet and other communication networks and the increase in the volume of communication have been accompanied with accelerated use of optical communications using optical fibers. Optical fibers are being laid not only to companies of course, but also general homes. The laying of communication lines using optical fibers has been accompanied by requests for laying optical fibers indoors so as to enable connection of the optical fibers to personal computers and other terminal equipment installed inside the general home.

At the present time, power cables and communications cables for telephones etc. are being laid indoors separately from and independently of each other. Therefore, to avoid complication of laying of cables, it is being considered to combine power cables and communication cables.

The example of a conventional composite cable of this type will be described with reference to FIG. 1 and FIG. 2.

A power cable 21 illustrated in FIG. 1 is comprised of insulated conductors 3A each comprised of conductors 1A including a plurality of power strand conductors and an insulator 2 provided at an outer circumference of the conductors 1A, a filler 5 interposed among the plurality of insulated conductors 3A and shown by hatching, a holding tape 6, and a covering 17. That is, the power cable 21 illustrated in FIG. 1 is obtained by twisting a filler 5 around three insulated conductors 3A arranged in a triangle, wrapping a holding tape 6 over it, then covering the assembly by a covering 17 in a circular shape. The power cable 21 illustrated in FIG. 1 does not contain an optical fiber, telephone cable, or other communication cable (line-shaped member) and consists of three insulated conductors 3A joined together. The three insulated conductors 3A are twisted together by a predetermined pitch in a state holding the triangular shape via the filler 5.

The composite power cable 22 able to be combined with a communication cable, illustrated in FIG. 2, is comprised of the power cable 21 illustrated in FIG. 1 plus one pipe 14. That is, the composite power cable 22 is configured by arranging three insulated conductors 3A and one pipe 14 via the filler 5 shown by the hatching in a square, twisting them together, wrapping a holding tape 6 over this, then covering the assembly by the covering 17 in a circular shape.

The pipe 14 is for insertion of a communication cable, for example, an optical fiber unit 12 illustrated in FIG. 4 formed by bundling a plurality of optical fibers 9 and providing an outer jacket 10, utilizing compressed air or manually when a demand for a communication cable etc. arises or when laying the composite power cable 22 indoors. As a communication line-shaped member inserted in the pipe 14, there is another communication cable etc. besides or together with the optical fibers illustrated in FIG. 4.

Generally, the state of laying the composite power cable 22 illustrated in FIG. 2 includes direct laying indoors under the ceiling, on the floor, on the wall, etc. When the composite power cable 22 is laid on the floor, external pressure from people, heavy objects, etc. is sometimes applied to the composite power cable 22. When the composite power cable 22 is laid under the ceiling or on the wall, external pressure from fasteners for fastening the composite power cable 22 is sometimes applied to the composite power cable 22.

The composite power cable 22 is rarely be laid in a straight line. The composite power cable 22 is usually laid bent sharply at several locations indoors. Therefore, for example, the composite power cable 22 illustrated in FIG. 2 having the pipe 14 for insertion of the optical fiber unit 12 having the optical fibers 9 illustrated in FIG. 4 may be structured to prevent a strong side pressure from being applied to the pipe 14 by providing a filler 5 of a buffer material, by reinforcing it by a covering 17, or by using an insulated pipe material resistant to outer pressure for the pipe 14.

Further, in view of the sharp bending in laying the composite power cable and the standards of power cables, for example, JISC3342, VVF, etc., the suitable pitch for twisting the insulated conductors 3A and the pipe 14 is considered about 30 times the radius of the layer core.

The above composite power cable 22 suffers from the problem of a burgeoning cost of the members of the composite power cable 22 due to the use of the filler (or the buffer) 5 provided in consideration of the side pressure etc., the use of a pipe material resistant to side pressure for a pipe 14, the use of the holding tape 6, and so on.

Further, the process of production includes a step of twisting together the insulated conductors 3A and the pipe 14, so the process of production of the composite power cable becomes complex and the manufacturing time also becomes long. Especially, since the members are twisted together by relatively short pitch in the above way since consideration is given to the bending etc. when laying the composite power cable, the problems are encountered that the manufacture is complex, the manufacturing time becomes long, and as a result the price of the composite power cable becomes more expensive.

Thus, the problem of the high price of the composite power cable becomes a serious obstacle especially when laying a large number of composite power cables to general homes.

Further, in the composite power cable 22 having the pipe 14 illustrated in FIG. 2, because the pipe 14 is twisted together with the insulated conductors 3A, the efficiency of insertion is low when inserting, for example, the optical fiber unit 12 illustrated in FIG. 4 into this pipe 14. In addition, at the portion where the composite power cable 22 is laid bent, the problem is encountered that the efficiency of insertion of the optical fiber unit 12 into the pipe 14 becomes low, the insertion of the optical fiber unit 12 becomes difficult, and the work efficiency becomes lower.

### DISCLOSURE OF THE INVENTION

According to the present invention, there is provided a composite power cable comprising at least one insulated conductor each comprised of a power conductor and an insulator provided at an outer circumference of said conductor; at least one pipe able to receive a communication cable; and a covering covering together said insulated conductor and said pipe, wherein said insulated conductor and said pipe are arranged in parallel in a line in a direction perpendicular to the longitudinal direction and extend substantially straight in the longitudinal direction and are covered by said covering and wherein the overall cross-section is flat.

Preferably, said pipe is arranged between two insulated conductors when there are at least two said insulated conductors.

More preferably, when a plurality of said pipes and a plurality of said insulated conductors are arranged, they are arranged so that one pipe and one insulated conductor alternate and so that said insulated conductors are positioned at the outside of said pipes.

Preferably, an outer diameter of said pipe is at least 1.2 times a maximum value of an outer diameter of said insulated conductor.

Preferably, said pipe is made of high density polyethylene resin.

Preferably, a groove is provided along a longitudinal direction of said composite power cable in a side surface of said covering, covering the overall assembly with a flat cross-section, perpendicular to a direction of arrangement of said pipe and said insulated conductor.

More preferably, a communication line-shaped member is received in said pipe in a state movable inside said pipe.

Specifically, said communication line-shaped member includes an optical fiber.

More specifically, said communication line-shaped member includes a line-shaped member of a conductor.

Preferably, electromagnetic shielding is applied to the pipe.

### BRIEF DESCRIPTION OF THE DRAWINGS

FIG. 1 is a cross-sectional view of a conventional power cable.

FIG. 2 is a cross-sectional view of a conventional composite power cable.

FIG. 3 is a cross-sectional view of a first embodiment of a composite power cable of the present invention.

FIG. 4 is a cross-sectional view of an optical fiber unit inserted in a pipe of the composite power cable of the present invention.

FIG. 5 is a cross-sectional view of one example of the structure of a flat-shaped low voltage power cable (JISC3342, VVF).

FIG. 6 is a cross-sectional view of a second embodiment of the composite power cable of the present invention.

FIG. 7 is a cross-sectional view of a third embodiment of the composite power cable of the present invention.

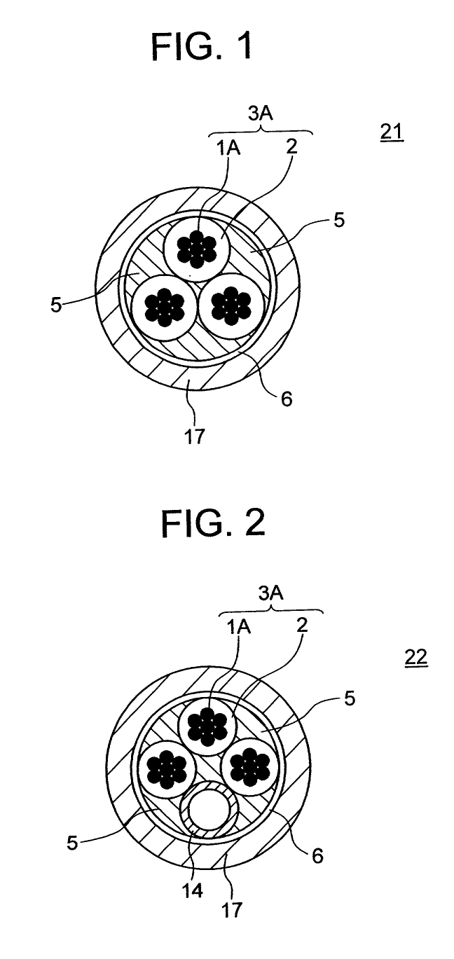

### BEST MODE FOR CARRYING OUT THE INVENTION

The above object and features of the composite power cable of the present invention will become clearer from the following description given with reference to the accompanying drawings.

First Embodiment

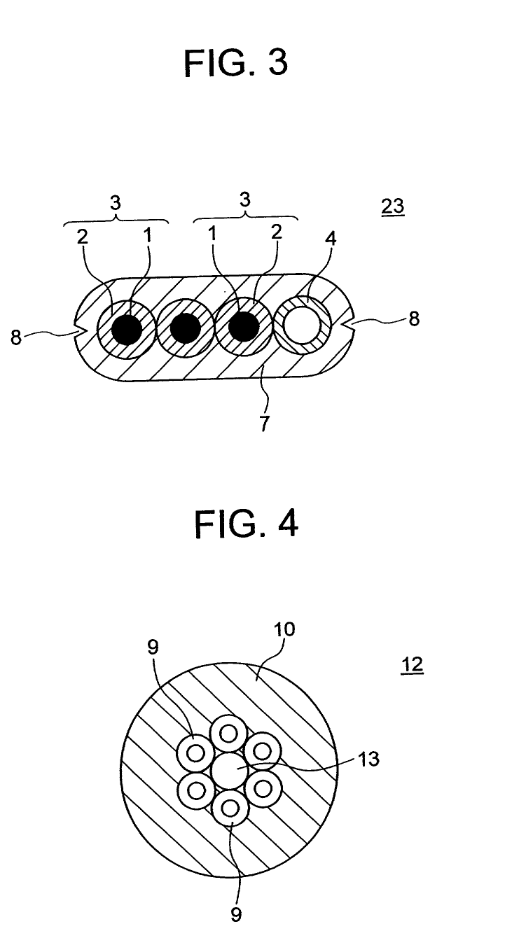

A composite power cable of a first embodiment of the present invention will be described with reference to FIG. 3 to FIG. 5.

FIG. 3 is a cross-sectional view of a first embodiment of the composite power cable of the present invention, while FIG. 4 is a cross-sectional view of an optical fiber unit inserted in a pipe of the composite power cable of the present invention.

The composite power cable 23 illustrated in FIG. 3 comprises a plurality of insulated conductors 3, each comprising a power conductor 1 and an insulator 2 provided at an outer circumference of the conductor 1, arranged in parallel; a pipe 4 arranged in parallel with these insulated conductors 3; a covering 7 covering the parallel arranged insulated conductors 3 and pipe 4 together; and V-shaped grooves 8 formed in the longitudinal direction in the two end parts of the covering 7. In this way, since the composite power cable 23 is comprised of a plurality of insulated conductors 3 and at least one pipe 4 arranged flat in parallel in a line and a covering 7 covering these having a flat cross-section, the cross-section of the composite power cable 23 has a flat shape as a whole.

In the composite power cable 23, the insulated conductors 3 and the pipe 4 are not twisted, but extend substantially straight longitudinal direction.

The optical fiber unit 12 illustrated in FIG. 4 as one example of a communication cable is inserted into the pipe 4.

The optical fiber unit 12, in the example illustrated in FIG. 4, is comprised of six optical fibers 9 arranged around a core support line 13 and an outer jacket 10 covering the same.

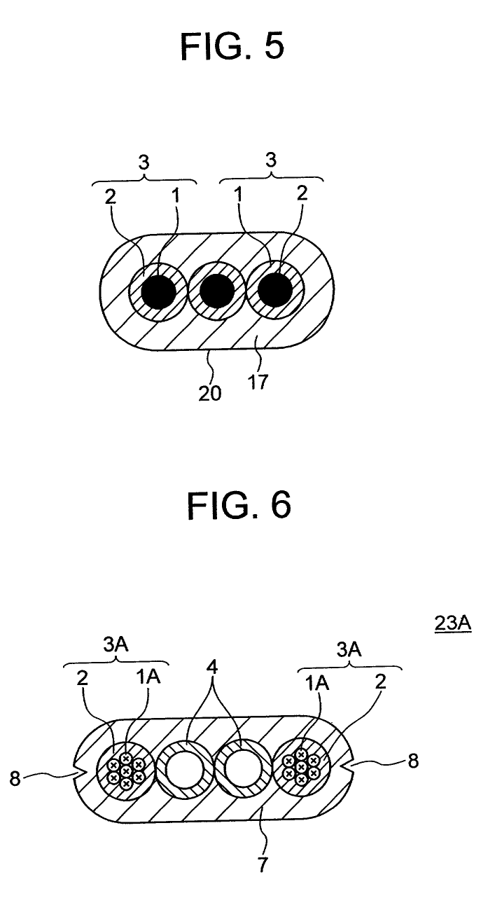

The composite power cable 23 of the first embodiment of the present invention illustrated in FIG. 3 is designed with reference to the flat-shaped indoor laid low voltage power cable 20 of the JISC3342, VVF standard illustrated in FIG. 5. The low voltage power cable 20 illustrated in FIG. 5 is comprised of a plurality of insulated conductors 3 each comprising of a power conductor 1 and an insulator 2, in the present example, three insulated conductors 3, arranged in parallel in a line.

The composite power cable 23 of the first embodiment of the present invention illustrated in FIG. 3 is structured as the low voltage power cable 20 illustrated in FIG. 5 plus a pipe 4.

The insulated conductor 3 in FIG. 3 is the same as the insulated conductor 3 in FIG. 5. Each insulated conductor 3 comprises, for example, a power conductor 1 for supplying low voltage, for example, AC 200V or AC 200V, to the general home and an insulator 2 provided at the outer circumference of the power conductor 1.

Details of the composite power cable 23 of the first embodiment of the present invention will be described next.

The composite power cable 23 of the first embodiment illustrated in FIG. 3, when laid in a house, preferably complies with the JISC3342, VVF standard of power cables such as the low voltage power cable 20 illustrated in FIG. 5. However, it is of course not limited to such a standard and also can be comprised of a power conductor 1 and insulator 2 in accordance with other standards.

The power conductor 1 forming part of the insulated conductor 3 may be either a single conductor as illustrated in FIG. 3 or a plurality of strand conductors which will be described below with reference to FIG. 6. For example, it is possible to produce a conductor 1 by electrical use soft copper wire of JISC3102 and use an insulator 2 made of Poly vinyl chloride compound meeting the standard of “Insulators” of Section 3 of JISC3342 or a plastic such as flame-retardant polyolefin to produce the insulated conductor 3.

The pipe 4 is for receiving the insertion of for example an optical fiber unit 12, illustrated in FIG. 4, comprised of a plurality of optical fibers 9 bundled together and outer jacket 10, for example, by making use of compressed air or manually by a worker when demand for a communication cable etc. arises after the composite power cable 23 has been laid. Of course, the composite power cable 23 can also be laid in a state with the optical fiber unit 12 inserted in the pipe 4 before the composite power cable 23 is laid.

The example in FIG. 3 shows one pipe 4, but the invention is not limited to one pipe 4. Regarding the number etc. of the pipes 4, the pipes 4 are inserted into the composite power cable 23 to the range of their outer diameter. For example, the inner diameter, outer diameter, and number of the pipes able to be inserted are determined by the outer diameter and number of the optical fiber units 12 illustrated in FIG. 4 or other communication line-shaped members. Therefore, a plurality of the pipes 4 illustrated in FIG. 3 can be inserted aligned laterally, but if considering the installation of the composite power cable 23 and other points and the outer diameter of a general cable used laid indoors, the number of the pipes 4 is suitably, for example, 2 to 3.

The pipe 4 can be produced, for example, by a high density polyethylene resin.

Since the pipe 4 in the composite power cable 23 illustrated in FIG. 3 is straight with no twists, by simply limiting the bending of the composite power cable 23 while laying it, it is easy to insert the optical fiber unit 12 illustrated in FIG. 4 or other communication line-shaped member into the pipe 4 by compressed air. Alternatively, by connecting the optical fiber unit 12 to a pulling line-shaped member such as an ordinary cable and having a worker pulls the pulling line-shaped member, the work of pulling the optical fiber unit 12 into the pipe 4 becomes easy.

Since the composite power cable 22 illustrated in FIG. 2 is comprised of the insulated conductors 3A and a pipe 14 twisted together, it was also necessary to insert the optical fiber unit 12 along the twisted pipe 14 so it was difficult to insert the optical fiber unit 12 into the pipe 14.

In addition, it was very difficult to insert the optical fiber unit 12 into the pipe 14 of the composite power cable 22 at the portion where the composite power cable 22 was laid in a bent state. Even if the composite power cable 23 illustrated in FIG. 3 is laid bent, since the pipe 4 is not twisted, there is little difficulty as in the composite power cable 22 when inserting the optical fiber unit 12.

Compared with the manufacture of the composite power cable 22 comprising the insulated conductors 3A and the pipe 14 twisted together, illustrated in FIG. 2, the composite power cable 23 illustrated in FIG. 3 does not have the insulated conductors 3 and the pipe 4 twisted, so there is no twisting step, manufacture is easy, the manufacturing time is short, and the manufacturing cost is low.

Regarding the external pressure applied when laying or after laying the composite power cable 23 illustrated in FIG. 3 as well, since insulated conductors 3 having substantially the same diameter as the pipe 4 are arranged laterally, it is possible to avoid the external pressure from concentrating at the pipe 4, so deformation of the pipe 4 seldom occurs.

When considering deformation of the pipe 4 by external pressure, preferably the outer diameter of the pipe 4 is made not more than 1.2 times the maximum value of the outer diameter of the insulated conductors 3. The reason is that even if assuming the pipe 4 is crushed by the external pressure, since the crushing is held to about 20 percent of the original outer diameter of the pipe 4, the flatness of the composite power cable 23 can be maintained. Further, if the outer diameter of the pipe 4 is not more than 1.2 times the maximum value of the outer diameter of the insulated conductors 3, the flatness of the composite power cable 23 can be maintained.

As a result, a buffer or other filler 5 or a pipe material resistant to side pressure or other member is not necessary as in the composite power cable 22 illustrated in FIG. 2. Further, as a result, it becomes possible to further lower the manufacturing cost of the composite power cable 23. Also, the composite power cable 23 becomes light and laying becomes even easier.

The covering 7 can be formed using Poly vinyl chloride compound conforming with the standard of “Sheaths” of Section 3 of JISC3342 or a flame-retardant polyolefin or other plastic after arranging the pipe 4 and the three insulated conductors 3 in a line laterally in the same direction.

Preferably, as illustrated, grooves 8 are formed in the two side surfaces of the covering 7. The shape of the grooves 8 illustrated is a V-shape, but the shape of the grooves 8 is not limited to a V-shape.

The thus configured composite power cable 23 illustrated in FIG. 3, considering the work efficiency at the time of connecting cables etc., is made so that the outer jacket can be torn by hand in a direction perpendicular to the grooves 8 at the two sides of the cable without using a special tool so as to facilitate the extraction of the insulated conductors 3 and the pipe 4 inside the composite power cable 23.

The communication line-shaped member (or wire or cable) received in the pipe 4 may be either the optical fiber unit 12 illustrated in FIG. 4 or a communication cable using ordinary copper wires. Note that the communication line-shaped member to be inserted into the pipe 4 preferably, for example, can be inserted using compressed air or inserted by the human hand using a pulling wire.

When using a conductive line-shaped member as a communication line-shaped member, from the viewpoint of preventing the electromagnetic induction hazard from the adjoining insulated conductors 3, it is preferable to apply electromagnetic shielding to the conductive communication line-shaped member or the pipe 4. Of course, when using an optical fiber unit 12 as a communication line-shaped member, it is not necessary to consider such electromagnetic induction hazard.

Second Embodiment

FIG. 6 is a cross-sectional view of a composite power cable 23A as a second embodiment of the composite power cable of the present invention.

The composite power cable 23A illustrated in FIG. 6 is comprised of two pipes 4 arranged in parallel between two insulated conductors 3A.

Each insulated conductor 3A illustrated in FIG. 6 is comprised of conductors 1A comprised of a plurality of strand conductors and an insulator 2 formed at circumference of the conductors 1A. The conductors 1A correspond to the conductors 1 of the composite power cable 23 illustrated in FIG. 3. Note that, in the composite power cable 23A in FIG. 6 as well, in the same way as the composite power cable 23 illustrated in FIG. 3, it is also possible to adopt the configuration of an insulated conductor 3 comprised of the conductor 1 and the insulator 2.

The pipe 4 itself, the covering 7 itself, and the grooves 8 are the same as those described with reference to FIG. 3.

If the pipes 4 are arranged inside the insulated conductors 3A as in the composite power cable 23A illustrated in FIG. 6, side pressure will not be directly applied to the pipes 4, so the possibility of the pipes 4 being crushed becomes lower.

When housing a plurality of the pipes 4 inside the composite power cable 23A, it is preferable to arrange the insulated conductors 3A at the outside of the pipes 4 to make it difficult for the side pressure to be directly applied to the pipes 4 from the viewpoint of prevention of deformation of the pipe 4 and protection of the original shape of the composite power cable 23A.

Third Embodiment

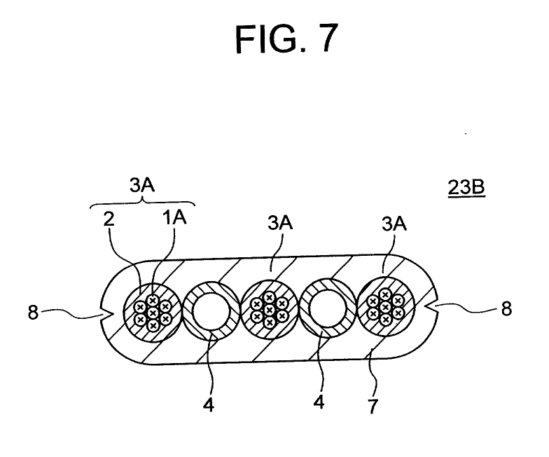

FIG. 7 is a cross-sectional view of a composite power cable 23B according to a third embodiment of the composite power cable of the present invention.

The composite power cable 23B illustrated in FIG. 7 is comprised of two pipes 4 arranged in parallel alternately with three insulated conductors 3A. Further, the outsides of the pipe 4, in the same way as the composite power cable 23A described with reference to FIG. 6, are protected by the insulated conductors 3A. The insulated conductor 3A comprised of conductors 1A and an insulator 2 itself, the pipe 4 itself, the covering 7 itself, and the grooves 8 are the same as those described with reference to FIG. 6. Note that, in the composite power cable 23B in FIG. 7 as well, in the same way as the composite power cable 23 illustrated in FIG. 3, it is also possible to configure the insulated conductors 3 by the conductor 1 and the insulator 2.

The composite power cable 23B illustrated in FIG. 7, in the same way as the composite power cable 23A illustrated in FIG. 6, is preferable from the viewpoint that side pressure is not directly applied to the pipes 4, so the possibility of the pipes 4 being crushed is lowered, deformation of the pipes 4 is prevented, and the original shape of the composite power cable 23B is protected.

In addition, when alternately arranging the insulated conductors 3A and the pipes 4, if the pipes 4 is formed by a material with a high electrical insulating property, for example, a high density polyethylene resin, there is an advantage that the insulation between the insulated conductors 3A becomes higher.

### EXAMPLES

Next, an explanation will be made of an example of the present invention based on the above embodiments.

As an example of the present invention, a composite power cable 23 of the structure illustrated in FIG. 3 having the insulated conductors 3 and the pipe 4 was prepared, then the optical fiber unit 12 in FIG. 4 was inserted into the pipe 4. Next, the mechanical properties and temperature characteristics of the composite power cable 23 with the optical fiber unit 12 inserted in the pipe 4 were evaluated. Further, the insertability of the optical fiber unit 12 in the composite power cable of the present invention was evaluated simulating the actual state of laying the cable. Details will be described below.

(1) Manufacture of Insulated Conductors 3

First, three insulated conductors 3, each comprised of a power conductor 1 of JISC3102 electrical use soft copper wire and 2 mm diameter covered by an insulator 2 made of Poly vinyl chloride compound conforming with the standard of “Insulators” of Section 3 of JISC3342 of a thickness of 0.8 mm, were prepared with surface colors of red, white, and black. The outer diameters of the insulated conductors 3 at this time were all about 3.6 mm.

(2) Manufacture of Pipe

Next, one pipe 4 having an outer diameter of 4 mm and an inner diameter of 2.5 mm and made of a high density polyethylene resin was prepared. In this example, the outer diameter of the pipe 4 was about 111 percent of the maximum value of the outer diameter of the insulated conductors 3.

(3) Arrangement and Covering of Insulated Conductors 3 and Pipe 4

A composite power cable 23 having V-shaped grooves 8 was prepared by arranging one pipe 4 in a line with three insulated conductors 3 in the same direction as the direction of arrangement of the conductors 3 and by covering them by a covering 7 of a flat shape having a long diameter of 18 mm and a short diameter of 6.6 mm made of a plastic made of Poly vinyl chloride compound conforming with the standard of “Sheaths” of Section 3 of JISC3342.

The covering thickness of the covering 7 was made 1.5 mm, the same as the covering thickness of the covering 17 in the conventional low voltage power cable 20, illustrated in FIG. 5, using said insulated conductors 3.

(4) Preparation of Communication Cable

The optical fiber unit 12 of FIG. 4 was made by twisting together six optical fibers 9 of outer diameters of 0.25 mm covered with an ultraviolet curing resin and covering them by an outer jacket 10 of polyethylene foam to give an outer diameter of 1.5 mm and a mass per unit length of 1.3 g/m. Here, a single mode optical fiber was used as the optical fiber 9.

Further, an optical fiber unit 12 was made in the same way as the optical fiber unit 12 using the above single mode optical fibers except for making the optical fibers 9 of FIG. 4 multi-mode optical fibers.

(5) Insertion of Communication Cable into Pipe 4

Composite power cables 23 were prepared by inserting these two kinds of optical fiber units 12 into pipes 4 of composite power cables 23 using air as a pressure medium.

(6) Various Experiments

Each composite power cable 23 manufactured in this way was subjected to side pressure, impact, torsion, bending, and other mechanical tests required for ordinary optical fiber cables and evaluated as to temperature characteristics. As a result, it was confirmed that each optical fiber unit 12 received in the pipe 14 had characteristics of no problem as an optical fiber cable.

The insertability was evaluated by an insertion test in a state with about 110 m of composite power cable 23 laid assuming indoor installation and provided with a total of 10 portions bent 90 degrees with a bending radius of 100 mm every 10 m. As a result, insertion into the pipe 4 was possible by an air pressure of not more than 0.8 MPa, that is, the pressure range of a commercially available compressor.

In the termination of the composite power cables 23, it was possible to tear the covering 7 from the V-shaped grooves 8 by hand without using a tool and possible to easily take out the insulated conductors 3 and the pipe 4.

Finally, the performance as a power cable was evaluated by using the test methods of JISC3005 to measure the conductor resistance, voltage resistance, insulation resistance, flame-retardance, etc. It was confirmed that the composite power cable 23 including insulated conductors 3 comprised of a conductor 1 and an insulator 2 satisfies the “Characteristics” of Section 3 of JISC3342.

While one example was given above, the composite power cable of the present invention may use insulated conductors 3 of at least all of JISC3342, VVF. The materials and dimensions etc. of the pipe 4, the optical fiber unit 12 used as the communication line-shaped member, and so on, are also not limited to this example.

For example, it is also possible to use a conductive line-shaped member as the communication line-shaped member. In this case, from the viewpoint of preventing electromagnetic induction hazard from the conductor 1, it is preferable to apply electromagnetic shielding to the conductive line-shaped member or pipe 4.

As the material of the covering 7 and the insulator 2, for example it is possible to use a flame-retardant polyolefin or other resin so long as it satisfies the characteristics of JISC3342 for-example.

Further, the method of insertion of the optical fiber unit 12 into the pipe 4 is also not limited to an insertion means using a pressure medium etc. so long as the cable is laid indoors etc. at a length of not more than 20 m and there are two to three bent parts. It may also be inserted by an insertion means using the hand or a pulling string etc. For this reason, the pipe 4 may also accommodate a pulling string or other line-shaped member in advance in a manner movable inside the pipe 4.

As explained above, in the composite power cable of the present invention, it is possible to reduce the manufacturing cost of the composite power cable in comparison with a cable of the conventional structure since the process of production does not include a twisting step.

Since the pipe is straight with no twists, the insertability of the optical fiber unit or other communication line-shaped member into the pipe becomes excellent and the work efficiency is improved.

Further, regarding crushing and other deformation of the pipe by external pressure applied to the composite power cable as well, since pipes having a diameter substantially the same or less than the outer diameter of the insulated conductors arranged in a line with the pipe are used, it is possible to avoid external pressure concentrating at the pipes. Therefore, crushing of the pipes and in turn crushing of the composite power cable and other deformation are eliminated. For this reason, there is no need for a filler used as a measure against crushing or a pipe material etc. resistant to crushing, so the cost of the composite power cable can be further reduced.

By providing grooves, for example, V-shaped grooves, at the two ends of a covering (outer jacket) of the composite power cable, it is possible to tear the covering easily to take out the insulated conductors and the pipes, so the work efficiency at the time of connection of the composite power cable connecting etc. becomes good.

Industrial Applicability

The composite power cable of the present invention may be used in various fields in which a power cable for supplying power and a communication line-shaped member for communication purposes are laid in a combined state.

List of References

1, 1A. conductor

2. insulator

3, 3A. insulated conductor

4, 14. pipe

5. filler

6. holding tape

7, 17. covering (outer jacket)

8. V-shaped groove

9. optical fiber

10. outer jacket

12. optical fiber unit

13. support line

20. low voltage power cable

21. power cable

22. composite power cable

23, 23A, 23B. composite power cable

1. A composite power cable comprising
at least one insulated conductor (3) each comprised of a power conductor (1) and an insulator (2) provided at an outer circumference of said conductor;
at least one pipe (4) able to receive a communication cable; and
a covering (7) covering together said insulated conductor (3) and said pipe (4), wherein
said insulated conductor (3) and said pipe (4) are arranged in parallel in a line in a direction perpendicular to the longitudinal direction and extend substantially straight in the longitudinal direction and are covered by said covering (7) and wherein
the overall cross-section is flat.

2. A composite power cable as set forth in claim 1, wherein said pipe (4) is arranged between two insulated conductors (3) when there are at least two said insulated conductors (3).

3. A composite power cable as set forth in claim 1, wherein when a plurality of said pipes (4) and a plurality of said insulated conductors (3) are arranged, they are arranged so that one pipe (4) and one insulated conductor (3) alternate and so that said insulated conductors (3) are positioned at the outside of said pipes (4).

4. A composite power cable as set forth in claim 1, wherein an outer diameter of said pipe (4) is at least 1.2 times a maximum value of an outer diameter of said insulated conductor (3).

5. A composite power cable as set forth in claim 1, wherein said pipe (4) is made of high density polyethylene resin.

6. A composite power cable as set forth in claim 1, wherein a groove (8) is provided along a longitudinal direction of said composite power cable in a side surface of said covering (7), covering the overall assembly with a flat cross-section, perpendicular to a direction of arrangement of said pipe (4) and said insulated conductor (3).

7. A composite power cable as set forth in claim 1, wherein a communication line-shaped member is received in said pipe (4) in a state movable inside said pipe (4).

8. A composite power cable as set forth in claim 7, wherein said communication line-shaped member includes an optical fiber.

9. A composite power cable as set forth in claim 7, wherein said communication line-shaped member includes a line-shaped member of a conductor.

10. A composite power cable as set forth in claim 9, wherein electromagnetic shielding is applied to said pipe (4).
